(19) United States
(12) Patent Application Publication
(10) Pub. No.: US 2012/0324164 A1
(43) Pub. Date: Dec. 20, 2012

(54) Programmable Memory Address

(75) Inventor: David Yiu-Man Lau, San Jose, CA (US)

(73) Assignee: MIPS TECHNOLOGIES, INC., Sunnyvale, CA (US)

(21) Appl. No.: 13/161,332

(22) Filed: Jun. 15, 2011

(51) Int. Cl. G06F 12/00; G06F 12/08; G06F 12/14

(52) U.S. Cl. 711/118; 711/154; 711/163; 711/E12.001; 711/E12.017; 711/E12.093

(57) ABSTRACT

A method includes storing defined memory address segments and defined memory address segment attributes for a processor. The processor is operated in accordance with the defined memory address segments and defined memory address segment attributes.

### FIELD OF THE INVENTION

This invention relates generally to memory management in computers. More particularly, this invention relates to programmed memory address segments.

### BACKGROUND OF THE INVENTION

Processors sold by MIPS Technologies®, Sunnyvale, Calif., use and handle addresses in a unique manner. FIG. 1 illustrates a MIPS virtual memory map for a 32-bit processor. The memory map includes fixed memory address segments. Each fixed memory address segment has fixed attributes, such as access mode, cache features and memory map features. In particular, there is a defined user mode region 102 and kernel mode regions 104, 106 and 108. More specifically, the memory map includes a user space region called “kuseg” 102. The user space region is a 2 GB region spanning virtual addresses 0x0000 0000 through 7FFF FFFF. These addresses are translated by a Memory Management Unit (MMU).

For the kernel mode, there is an unmapped cached region called “kseg0” 104. This region is 512 MB ranging from virtual address 0x8000 000 through 9FFF FFFF. These virtual addresses are translated into physical addresses by stripping off the top 3 most significant bits and mapping them contiguously into the lower 512 MB of physical memory. Addresses in this region are almost always accessed through the cache. The addresses are used for most programs and data in systems not using an MMU and are used by the Operating System (OS) kernel for systems that do use an MMU.

The unmapped and uncached region is called “kseg1” 106. This region is also 512 MB, with virtual addresses ranging from 0xA000 0000 through BFFF FFFF. These virtual addresses are mapped into physical addresses by stripping off the leading 3 bits, giving a duplicate mapping of the lower 512 MB of physical memory. In this space, access does not rely upon the cache.

The mapped region is called “kseg2” 108. This 1 GB region spans virtual addresses 0xC000 0000 through FFFF FFFF. This area is only accessible in kernel mode. This region is translated through the MMU.

Since the memory segments are fixed, a user is not able to optimize a machine for a particular application, such as processing large media files in the form of streaming media. For example, it might be desirable to have a larger unmapped memory segment to access such large files.

Therefore, it would be desirable to provide a mechanism to accommodate optimized processing modes. Such a mechanism should support the definition of memory segment attributes, such as access modes, cache features and memory map features.

### SUMMARY OF THE INVENTION

A method of converting fixed memory address segments into programmable memory address segments includes storing defined memory address segments and defined memory address segment attributes. The processor is operated in accordance with the defined memory address segments and defined memory address segment attributes.

A computer includes a memory and a processor connected to the memory. The processor includes memory segment configuration registers to store defined memory address segments and defined memory address segment attributes such that the processor operates in accordance with the defined memory address segments and defined memory address segment attributes.

A processor includes memory segment configuration registers to store defined memory address segments and defined memory address segment attributes such that the processor operates in accordance with the defined memory address segments and defined memory address segment attributes.

A computer readable storage medium includes executable instructions to define a processor with a fixed memory address mapping. Memory segment configuration registers store defined memory address segments and defined memory address segment attributes such that the processor operates in accordance with the defined memory address segments and defined memory address segment attributes.

### BRIEF DESCRIPTION OF THE FIGURES

The invention is more fully appreciated in connection with the following detailed description taken in conjunction with the accompanying drawings, in which:

FIG. 1 illustrates a prior art fixed memory segment scheme.

FIG. 2 illustrates a computer configured in accordance with an embodiment of the invention.

FIG. 3 illustrates a programmable memory segment scheme in accordance with an embodiment of the invention.

FIG. 4 illustrates processing operations associated with an embodiment of the invention.

Like reference numerals refer to corresponding parts throughout the several views of the drawings.

### DETAILED DESCRIPTION OF THE INVENTION

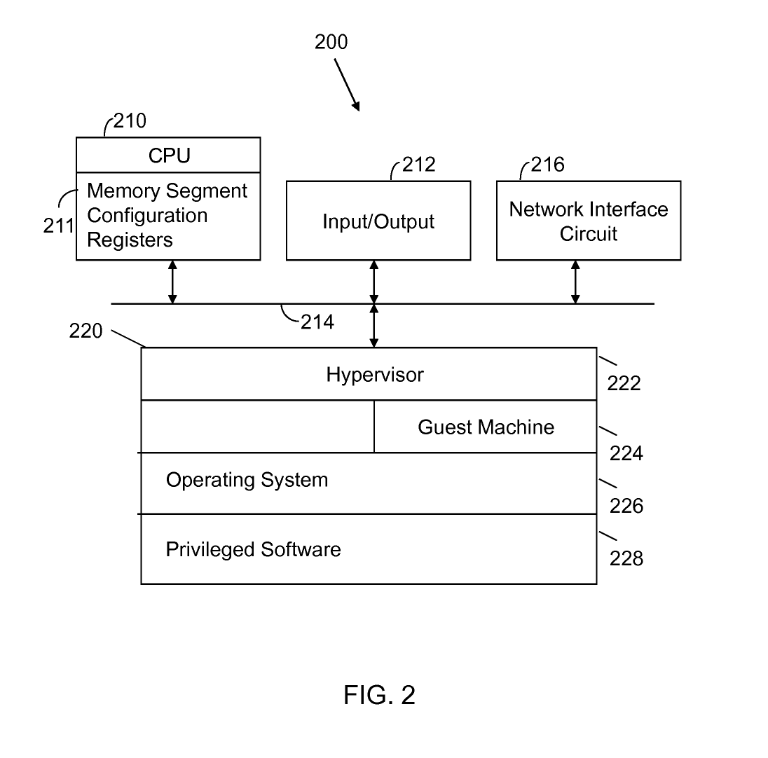

FIG. 2 illustrates a computer 200 implemented in accordance with an embodiment of the invention. In one embodiment, the computer 200 is a host machine with a central processing unit 210. The central processing unit 210 includes memory segment configuration registers 211. The memory segment configuration registers facilitate a customized definition of a memory map. For example, the memory segment configuration registers may specify a number of defined memory address segments and memory address segment attributes, such as access mode, cache feature and/or memory map feature.

This stands in contrast to the prior art. In the prior art, the accessibility mode (e.g., kernel only, kernel and supervisor, or kernel and supervisor and user) is fixed for each segment. (A chosen segment is defined by the most significant address bits.) The mapability (e.g., use of memory management unit and translation look-aside buffer) is fixed for each segment. Finally, the cache-ability (e.g., the use of a cache) is also fixed for each segment. In an embodiment of the invention, the accessibility mode per segment is programmed into memory segment configuration registers 211 by privileged software, normally at power-up. Similarly, the map-ability per segment is programmed, as is the cache-ability per segment. As in the legacy system, the chosen segment is defined by the most significant address bits.

The computer 200 also includes input/output devices 212, which are connected to the CPU 210 via a bus 214. The input/output devices 212 may include a keyboard, mouse, display, printer and the like. A network interface circuit 216 is also connected to the bus 214. The network interface circuit 216 allows the computer 200 to operate in a networked environment.

A memory 220 is also connected to the bus 214. In one embodiment, the memory 220 stores a hypervisor 212, which may be used to implement a guest machine 224. This allows for virtualization of hardware resources. Virtualization refers to the creation of a virtual, rather than an actual, version of something, such as a hardware platform, operating system, a storage device or a network resource. For example, a computer that is running Microsoft® Windows® may host a virtual machine that looks like a computer with an Apple® operating system. Therefore, Apple® compliant software can be executed on the virtual machine.

In hardware virtualization, the term host machine refers to the actual machine on which the virtualization takes place. The term guest machine refers to the virtual machine. The software or firmware that creates a virtual machine on the host machine is called a hypervisor. In the MIPS legacy virtual address map, KSEG0 and KSEG1 cannot be relocated, which hinders virtualization.

The memory segment configuration registers 211 facilitate virtualization operations. However, the memory segment configuration registers 211 need not be used in connection with virtualization operations. Rather, the memory segment configuration registers 211 may be used in any number of modalities. For example, the memory segment configuration registers 211 may be used in connection with a standard operating system 226. The memory 220 may also store privileged software 228, which is used to write values to the memory segment configuration registers 211, typically at power-up.

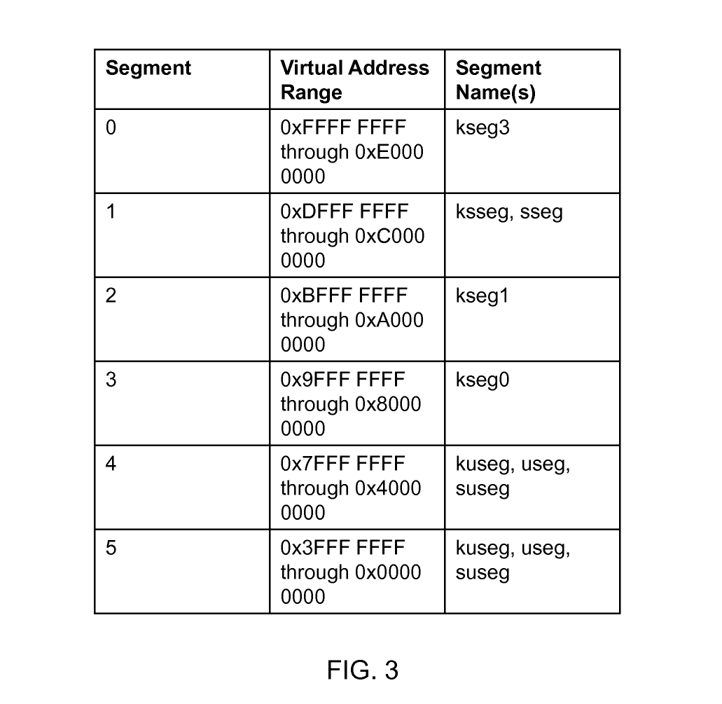

FIG. 3 illustrates a 32-bit address space that may be divided into a set of custom memory segments in accordance with an embodiment of the invention. In this embodiment, there are six defined memory address segments. Exemplary virtual address ranges and segment names are also provided in FIG. 3. For segment 0, a segment register (e.g., SegReg0) may store memory address segment attributes defining access mode, cache-ability and map-ability. Corresponding segment register numbers may be used to store programmed values for the remaining segments.

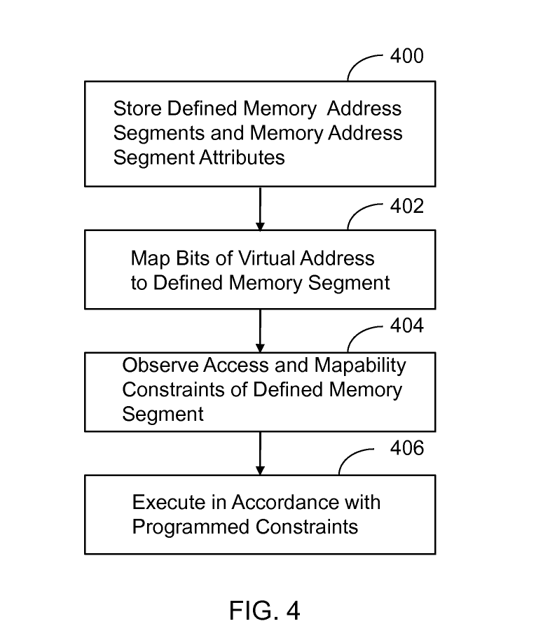

FIG. 4 illustrates processing operations associated with an embodiment of the invention. Initially, defined memory address segments and memory address segment attributes are stored 400. For example, privileged software 228 may write values to the memory segment configuration registers 211. Thereafter, when a virtual address is received, bits from the virtual address are mapped to a defined memory segment 402. For example, the upper bits of the virtual address may be examined for mapping to a defined memory segment. The access and mapability constraints of the defined memory segment are then observed 404. An operation is then performed in accordance with the programmed constraints 406. For example, the programmed constraints may specify if access is allowed. If access is not allowed, then an exception is thrown. If access is allowed, then mapping constraints are checked. For example, if mapped access is not allowed, the upper bits of the virtual address may be dropped and the remaining bits may be used as a physical address. If mapped access is allowed, then a translation look-aside buffer (TLB) may be accessed with the virtual address. The TLB then outputs a physical address.

The memory segment configuration registers 211 may be implemented to set the following parameters:
access permissions from user, kernel, and supervisor modes;
enable mapping (address translation) using a memory management unit (MMU);
physical address when mapping is disabled;
cache attribute when mapping is disabled; and
force to unmapped, uncached.

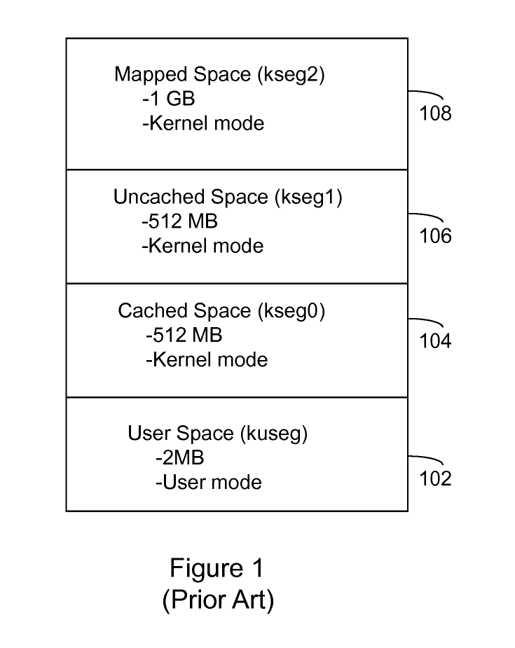

Preferably, on reset, all segment configurations default to the fixed memory segment configuration of FIG. 1.

The memory segment configuration registers may be used to implement a fully translated flat address space. Alternately, they may be used to alter the relative size of cached and uncached windows into the physical address space.

This segmentation control is more fully appreciated in connection with the following example, which includes annotations.

/* Inputs
* vAddr - Virtual Address
* pLevel - Privilege level - USER, SUPER, KERNEL
* IorD - Access type - INSTRUCTION or DATA
* LorS - Access type - LOAD or STORE
*
* Outputs
* mapped - segment is mapped
* pAddr - physical address (valid when unmapped)
* CCA - .cache attribute (valid when unmapped)
*
* Exceptions: Address Error
*/
subroutine SegmentLookup(vAddr, pLevel, IorD, LorS) :

Index = vAddr[31:29]
case Index

7: CFG ← SegCtlO.CFGO
6: CFG ← SegCtlO.CFG1
5: CFG ← SegCt11.CFG2
4: CFG ← SegCt11.CFG3
3: CFG ← SegCtl2.CFG4
2: CFG ← SegCtl2.CFG4
1: CFG ← SegCtl2.CFG5
0: CFG ← SegCtl2.CFG5

| Endcase | |
|---|---|
| AM | ← CFG.AM |

#AM: access control mode

| | |
|---|---|
| EU | ← CFG.EU |

#EU: error condition behavior

| | |
|---|---|
| PA | ← CFG.PA |

#PA: physical address bit for segment

| | |
|---|---|
| C | ← CFG.C |

#C: cache coherency attribute

checkAM(AM,pLevel,TorD,LorS)
# Special case - Error-Unmapped region when ERL=1
if (EU = 1) and (Status_{ERL}=1) then

| | |
|---|---|
| CCA ← 2 | # uncached |
| mapped ← 0 | # unmapped |

else

CCA ← C
mapped ← isMapped(AM, pLevel,IorD, LorS)

endif
# Physical address for unmapped use
if (mapped = 0) then

# in a large (1gb) segment, drop the low order bit.
if (Index < 4) then

pAddr[31:30] ← PA[2:1]

else

pAddr[31:29] ← PA

endif

else

(CCA,pAddr) ← TLBLookup(vAddr)

endif
return (mapped, pAddr, CCA)

endsub
# Access mode check
subroutine checkAM(AM, pLevel, IorD, LorS)

case AM

| | |
|---|---|
| UK: | seg_err ← (pLevel != KERNEL) |

#UK: Kernel-only unmapped region, e.g.,
kseg0, kseg1

| | |
|---|---|
| MK: | seg_err ← (pLevel != KERNEL) |

| | #MK: Kernel-only mapped region, e.g., kseg3 |
|---|---|
| MSK: | seg_err ← (pLevel = USER) |
| | #MSK: Supervisor and kernel mapped region, |
| | e.g., ksseg, sseg |
| MUSK: | seg_err ← 0 |

#MUSK: User, supervisor and kernel mapped
region
#e.g., useg, kuseg, suseg

| | |
|---|---|
| MUSUK: | seg_err ← 0 |

#MUSUK: Used to implement a fully-mapped flat
address space in
#user and supervisor modes, with unmapped
regions which appear
#in kernel mode

| | |
|---|---|
| USK: | seg_err ← (pLevel = USER) |

| | #USK: Supervisor and kernel unmapped region |
|---|---|
| | #e.g., sseg in a fixed mapping TLB |
| UUSK: | seg_err ← 0 |

#UUSK: Unrestricted unmapped region

default: seg_err ← UNDEFINED

endcase
if (seg_err != 0) then

segmentError(IorD, LorS)

endif

endsub
subroutine isMapped(AM, pLevel,IorD, LorS)

case AM

UK: mapped ← 0
MK: mapped ← 1
MSK: mapped ← 1
MUSK: mapped ← 1
MUSUK: mapped ← (pLevel != KERNEL)
USK: mapped ← 0
UUSK: mapped ← 0
default: mapped ← UNDEFINED

endcase
return mapped

endsub
subroutine segmentError(IorD, LorS)

if (IorD = INSTRUCTION) then

reftype ← FETCH

else

if (LorS = LOAD) then

reftype ← LOAD

else

reftype ← STORE

endif

endif
SignalException(AddrError, reftype)

endsub

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.).

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A method, comprising:
storing defined memory address segments and defined memory address segment attributes; and
operating the processor in accordance with the defined memory address segments and defined memory address segment attributes.

2. The method of claim 1 wherein storing includes storing an access permission defined memory address segment attribute.

3. The method of claim 2 wherein storing includes storing an access permission selected from user mode, kernel mode and supervisor mode.

4. The method of claim 1 wherein storing includes storing a cache feature defined memory address segment attribute, wherein the cache feature defines access to addresses within a defined memory address segment.

5. The method of claim 1 wherein storing includes storing a memory map feature defined memory address segment attribute, wherein the memory map feature specifies use of a translation look-aside buffer for an address within a defined memory address segment.

6. A computer, comprising:
a memory; and
a processor connected to the memory, wherein the processor includes memory segment configuration registers to store defined memory address segments and defined memory address segment attributes such that the processor operates in accordance with the defined memory address segments and defined memory address segment attributes.

7. The computer of claim 6 wherein the segment configuration registers store an access permission defined memory address segment attribute.

8. The computer of claim 7 wherein the access permission is selected from user mode, kernel mode and supervisor mode.

9. The computer of claim 6 wherein the segment configuration registers store a cache feature defined memory address segment attribute, wherein the cache feature defines access to addresses within a defined memory address segment.

10. The computer of claim 6 wherein the segment configuration registers store a map feature defined memory address segment attribute, wherein the map feature specifies use of a translation look-aside buffer for an address within a defined memory address segment.

11. The computer of claim 6 wherein the segment configuration registers store a memory segment index size.

12. A processor, comprising:
memory segment configuration registers to store defined memory address segments and defined memory address segment attributes such that the processor operates in accordance with the defined memory address segments and defined memory address segment attributes.

13. The processor of claim 12 wherein the memory segment configuration registers store an access permission defined memory address segment attribute.

14. The processor of claim 13 wherein the access permission is selected from user mode, kernel mode and supervisor mode.

15. The processor of claim 12 wherein the memory segment configuration registers store a cache feature defined memory address segment attribute, wherein the cache feature defines access to addresses within a defined memory address segment.

16. The computer of claim 12 wherein the memory segment configuration registers store a map feature defined memory address segment attribute, wherein the map feature specifies use of a translation look-aside buffer for an address within a defined memory address segment.

17. A computer readable storage medium including executable instructions to define a processor, comprising:
memory segment configuration registers to store defined memory address segments and defined memory address segment attributes such that the processor operates in accordance with the defined memory address segments and defined memory address segment attributes.

18. The computer readable storage medium of claim 17 wherein the memory segment configuration registers store an access permission defined memory address segment attribute.

19. The computer readable storage medium of claim 17 wherein the memory segment configuration registers store a cache feature defined memory address segment attribute, wherein the cache feature defines access to addresses within a defined memory address segment.

20. The computer readable storage medium of claim 17 wherein the memory segment configuration registers store a map feature defined memory address segment attribute, wherein the map feature specifies use of a translation look-aside buffer for an address within a defined memory address segment.

21. The computer readable storage medium of claim 17 wherein the segment configuration registers store a memory segment index size.
